(19) United States
(12) Patent Application Publication
(10) Pub. No.: US 2024/0178967 A1
(43) Pub. Date: May 30, 2024

(54) METHODS OF TWO DOWNLINK CHANNEL STATE INFORMATION AND TWO UPLINK CHANNEL STATE INFORMATION FOR FULL DUPLEX SYSTEM

(71) Applicant: MediaTek Singapore Pte. Ltd., Singapore (SG)

(72) Inventors: Chandrasekaran Mohandoss, Bengaluru (IN); Chien-Hua Chen, Hsinchu City (TW); Yih-Shen Chen, Hsinchu City (TW)

(21) Appl. No.: 18/508,169

(22) Filed: Nov. 13, 2023

(30) Foreign Application Priority Data
Nov. 18, 2022 (IN) 202221066337

(51) Int. Cl. H04L 5/00; H04L 5/14; H04W 72/0446

(52) U.S. Cl. CPC H04L 5/0051; H04L 5/14; H04W 72/0446

(57) ABSTRACT

Apparatus and methods are provided downlink and uplink CSI and power control for subband full duplex (SBFD) system. In one novel aspect, two CSI-RS configurations are configured for DL CSI, one for the DL-only slots and one for the SBFD slots. In one embodiment, the UE performs channel estimation individually using the CSI-RS configured for the DL-only slots and the SBFD slots. In another embodiment, the CSI-RS signals are periodic or aperiodic. The periodicity of CSI-RS for SBFD slots and DL-only slots are different. In one embodiment, the UE receives a first SRS configuration for UL-only slots and a second SRS configuration for the SBFD slots, transmits the SRS signals on UL-only slots and SBFD slots based on the first SRS configuration and the second SRS configuration.

In another novel aspect, the UE receives two different sets of power control parameters for UL-only slots and the SBFD slots.

### CROSS REFERENCE TO RELATED APPLICATIONS

This application claims priority under 35 U.S.C. § 119 from Indian Application Number 202221066337, titled “METHODS OF TWO DOWNLINK CHANNEL STATE INFORMATION AND TWO UPLINK CHANNEL STATE INFORMATION FOR FULL DUPLEX SYSTEM, ” filed on Nov. 18, 2022. The disclosure of each of the foregoing documents is incorporated herein by reference.

### TECHNICAL FIELD

The disclosed embodiments relate generally to wireless communication, and, more particularly, downlink (DL) and uplink (UL) channel state information (CSI) for full duplex system.

### BACKGROUND

The evolution of wireless communication technologies has been marked by continuous advancements aimed at enhancing data rates, reducing latency, and increasing network capacity. Full-duplex communication enables simultaneous transmission and reception on the same frequency channel. Within the realm of evolving wireless network, Subband Full Duplex (SBFD) is emerging as a promising solution to address the ever-increasing demand for high-speed, low-latency wireless connectivity. Full-duplex communication, in its essence, allows a wireless device to transmit and receive data simultaneously on the same frequency band, effectively doubling the available bandwidth and improving spectral efficiency. Traditional communication systems employ half-duplex operation, where a device can either transmit or receive data at a given moment. Full-duplex operation promises to revolutionize wireless communication by mitigating the limitations of half-duplex systems, such as increased latency and reduced network capacity.

Subband Full Duplex System takes full-duplex communication a step further by utilizing a subband allocation approach. Instead of transmitting and receiving on the entire frequency band, this system divides the available spectrum into smaller subbands. Each subband is then allocated for specific transmission and reception tasks. Although SBFD provides flexibility and offers more efficiency for the wireless system, it poses new challenges in areas such as channel state information estimation due to the potential additional interferences.

Improvements and enhancements are required for UL and DL channel state information for full duplex system.

### SUMMARY

Apparatus and methods are provided downlink and uplink CSI for full duplex system. In one novel aspect, two CSI-reference signal (CSI-RS) configurations and two CSI reports are configured for DL CSI including one for the DL-only slots and one for the SBFD slots. In one embodiment, the UE receives a first CSI-RS configuration for DL-only slots and a second CSI-RS configuration for SBFD slots, wherein each CSI-RS configuration includes configurations for channel measurement resources (CMR) and interference measurement resources (IMR), receives CSI-RS signals on DL-only slots and DL resources of SBFD slots based on the first and the second CSI-RS configuration and performs CSI measurements of the CSI-RS signals. In one embodiment, the UE estimates interference covariance individually on IMRs for DL-only slots and the SBFD slots. In another embodiment, a common CMR is configured for DL-only slots and the SBFD slots. In one embodiment, the UE performs channel estimation using the CSI-RS configured for the SBFD slots. In one embodiment, CMR contents for the first RS configuration and the second RS configuration are different. The UE performs channel estimation individually using the CSI-RS configured for the DL-only slots and CSI-RS configured for SBFD slots. In another embodiment, the CSI-RS signals are periodic or aperiodic, and wherein for periodic CSI-RS signals the periodicity of CSI-RS for SBFD slots and DL-only slots are different. In one embodiment, the UE receives a first SRS configuration for UL-only slots and a second SRS configuration for the SBFD slots, transmits the SRS signals on UL-only slots and SBFD slots based on the first SRS configuration and the second SRS configuration. In one embodiment, the SRS signals are periodic or aperiodic, and wherein for periodic SRS signals the periodicity of SRS for SBFD slots and UL-only slots are different.

In another novel aspect, the base station configures a first SRS configuration for uplink (UL)-only slots and a second SRS configuration for subband full duplex (SBFD) slots, transmits the first SRS configuration and the second SRS configuration to one more UEs in the wireless network, receives SRS signals on UL-only slots and UL resources of SBFD slots based on the first SRS configuration and the second SRS configuration, and estimates two UL CSI using a channel measurement and an interference covariance based on the received SRS signals. In one embodiment, base station performs channel estimation individually using the SRS for the UL-only slots and SRS for SBFD slots. In another embodiment, the base station performs joint channel estimation (JCE) across at least two SBFD slots. In yet another embodiment, the base station estimates the interference covariance individually using received demodulation reference signal (DMRS) individually on UL-only slots and UL resources of SBFD slots. In one embodiment, the SRS signals are periodic or aperiodic, and wherein for periodic SRS signals the periodicity of SRS for SBFD slots and UL-only slots are different.

In yet another embodiment, the UE receives first set of power control parameters for uplink (UL)-only slots and a second set of power control parameters for subband full duplex (SBFD) slots, and performs power control based on the first set of power control parameters and the second set of power control parameters. In one embodiment, a first P_0 and a first P_boost are included in the first set of power control parameters and a second P_0 and a second P_boost are included in the second set of power control parameters, and wherein the first P_0 is different from the second P_0.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network configured with SBFD that supports optimization operations in accordance with embodiments of the current invention.

FIG. 2 is a simplified block diagram of a gNB and a UE in accordance with embodiments of the present invention.

FIG. 3 illustrates exemplary diagrams different configuration of subband full duplexing frame structures in accordance with embodiments of the current invention.

FIG. 4 illustrates exemplary diagrams for SBFD deployment scenarios including single cell SBFD and multi-cell SBFD scenario in accordance with embodiments of the current invention.

FIG. 5 illustrates exemplary diagrams for SBFD signaling to SBFD-considered UE and SBFD-unaware UEs in accordance with embodiments of the current invention.

FIG. 6 illustrates exemplary flow diagrams for DL CSI configuration and CSI report for SBFD enabled system in accordance with embodiments of the current invention.

FIG. 7 illustrates exemplary flow diagrams for UL SRS configuration and SRS measurements for SBFD enabled system in accordance with embodiments of the current invention.

FIG. 8 illustrates exemplary diagrams for coverage extension with repetition transmission on the multiple SBFD slots in accordance with embodiments of the current invention.

FIG. 9 illustrates exemplary diagrams for uplink control with different UL power control parameters configured for the UL-only slots and the SBFD slots in accordance with embodiments of the current invention.

FIG. 10 illustrates an exemplary flow chart for the UE to perform CSI for SBFD enabled channel in accordance with embodiments of the current invention.

FIG. 11 illustrates an exemplary flow chart for the gNB to perform CSI for SBFD enabled channel in accordance with embodiments of the current invention.

FIG. 12 illustrates an exemplary flow chart for the UE to perform UL power control for SBFD enabled channel in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system. Also please note that even some embodiments are described in 5G context, the invention can be applied to 6G or other radio access technology.

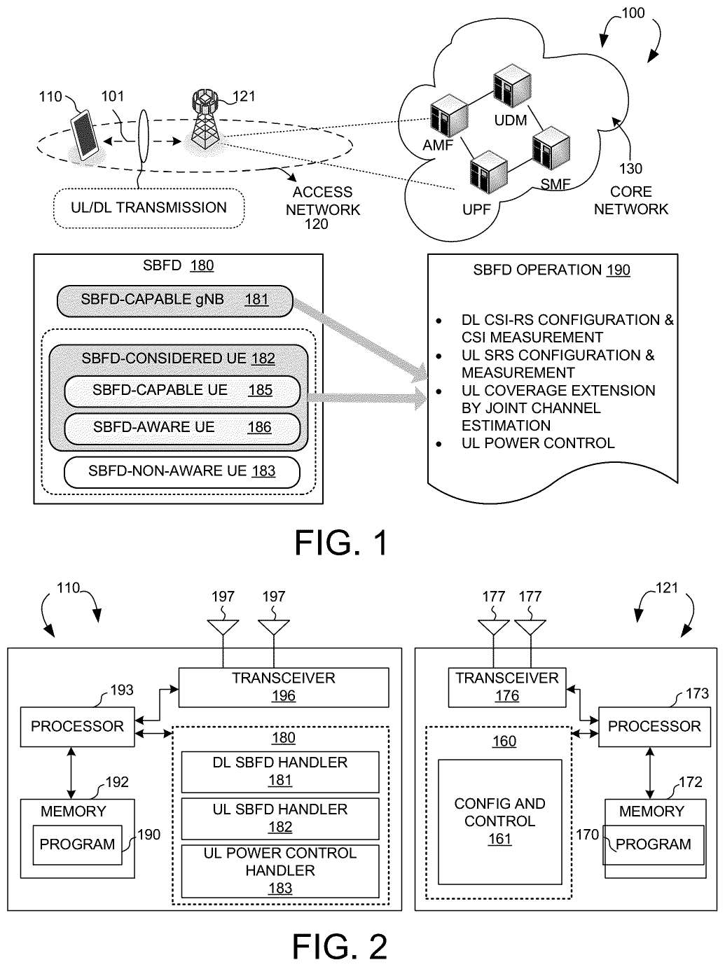

FIG. 1 is a schematic system diagram illustrating an exemplary wireless network configured with SBFD that supports optimization operations in accordance with embodiments of the current invention. The wireless network 100 includes a user equipment (UE) 110 communicatively connected to a gNB 121 operating of an access network 120 which provides radio access using a Radio Access Technology (RAT). The access network 120 is connected to a core network 130 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The gNB 121 may provide communication coverage for a geographic coverage area in which communications with the UE 110 is supported via a communication link 101. The communication link 101 shown in the B5G/6G network 100 may include UL transmissions from the UE 110 to the gNB 121 (e.g., on the Physical Uplink Control Channel (PUCCH) or Physical Uplink Shared Channel (PUSCH)) or downlink (DL) transmissions from the gNB 121 to the UE 110 (e.g., on the Physical Downlink Control Channel (PDCCH) or Physical Downlink Shared Channel (PDSCH)).

The UE 110 may be a smart phone, a wearable device, an Internet of Things (IOT) device, and a tablet, etc. Alternatively, UE 110 may be a Notebook (NB) or Personal Computer (PC) inserted or installed with a data card which includes a modem and RF transceiver (s) to provide the functionality of wireless communication. In one novel aspect, SBFD is configured for wireless network 100. The main benefits of SBFD are to support low latency with low round-trip time and large coverage. The availability of more frequent DL and UL resources can reduce the latency of both DL and UL. For example, the UL coverage is normally the bottleneck in the network. Using repetition of UL data in the consecutive or more frequent UL resources can increase the UL coverage. In one embodiment 180, network entities, including UEs and gNBs are equipped and/or configured with different capacity for SBFD. As an example, wireless network 100 includes one or more SBFD-capable gNBs 181, one or more SBFD-capable UE 185, one or more SBFD-aware UEs 186, and one or more SBFD-non-aware UEs 183. SBFD capable gNBs 181 support full duplexing and use the SBFD features. SBFD-capable UEs 185 support full duplexing and use the SBFD features. SBFD-aware UEs 186 cannot support full duplexing but are aware of the SBFD features. SBFD-non-aware/SBFD-unaware UEs 183 cannot support full duplexing and are unaware of the SBFD features. The SBFD unaware UEs 183 cannot understand the SBFD configuration signaling from the gNB and cannot be scheduled for uplink the SBFD slots. In one embodiment, the SBFD-capable UE 185 and the SBFD-aware UE 186 are categorized as SBFD-considered UE 182. In one novel aspect 190, SBFD operations are provided including DL CSI-RS configuration and CSI measurement reports configuration for SBFD enabled system; UL SRS configuration and measurements for SBFD enabled system; UL coverage extension and joint channel estimation (JCE) for SBFD enabled system; and UL power control for SBFD enabled system.

FIG. 2 is a simplified block diagram of a gNB 121 and a UE 110 in accordance with embodiments of the present invention. For the gNB 121, antennas 177 transmit and receive radio signal under MIMO network. A radio frequency (RF) transceiver module 176, coupled with the antennas, receives RF signals from the antennas, converts them to baseband signals and sends them to processor 173. RF transceiver 176 also converts received baseband signals from the processor 173, converts them to RF signals, and sends out to antennas 177. Processor 173 processes the received baseband signals and invokes different functional modules and circuits to perform features in the gNB 121. Memory 172 stores program instructions and data 170 to control the operations of the gNB 121.

Similarly, for the UE 110, antennae 197 transmit and receive RF signal under MIMO network. RF transceiver module 196, coupled with the antennas, receives RF signals from the antennas, converts them to baseband signals and sends them to processor 193. The RF transceiver 196 also converts received baseband signals from the processor 193, converts them to RF signals, and sends out to antennas 197. Processor 193 processes the received baseband signals and invokes different functional modules and circuits to perform features in the UE 110. Memory 192 stores program instructions and data 190 to control the operations of the UE 110. Although a specific number of the antennas 177 and 197 are depicted in FIG. 2, it is contemplated that any number of the antennas 177 and 197 may be introduced under the MIMO network.

The gNB 121 and the UE 110 also include several functional modules and circuits that can be implemented and configured to perform embodiments of the present invention. In the example of FIG. 2, the gNB 121 includes a set of control functional modules and circuit 160. Configuration and control circuit 161 provides different parameters to configure and control UE 110. UE 110 includes a set of control functional modules and circuit 180. DL SBFD handler 181 receives a first channel status information (CSI) reference signal (RS) configuration for downlink (DL)-only slots and a second CSI-RS configuration for subband full duplex (SBFD) slots, and wherein each CSI-RS configuration includes configurations for channel measurement resource (CMR) and interference measurement resource (IMR), receives CSI-RS signals on DL-only slots and DL resources of SBFD slots based on the first CSI-RS configuration and the second CSI-RS configuration, and performs channel status information (CSI) measurements of the CSI-RS signals. UL SBFD handler 182 receives a first sounding reference signal (SRS) configuration for uplink (UL)-only slots and a second SRS configuration for SBFD slots, transmits SRS signals on UL-only slots and SBFD slots based on the first SRS configuration and the second SRS configuration. A UL power control handler 183 receives a first set of power control parameters for uplink (UL)-only slots and a second set of power control parameters for subband full duplex (SBFD) slots and performs power control based on the first set of power control parameters and the second set of power control parameters.

Note that the different functional modules and circuits can be implemented and configured by software, firmware, hardware, and any combination thereof. The function modules and circuits, when executed by the processors 193 and 173 (e.g., via executing program codes 190 and 170), allow the gNB 121 and the UE 110 to perform embodiments of the present invention.

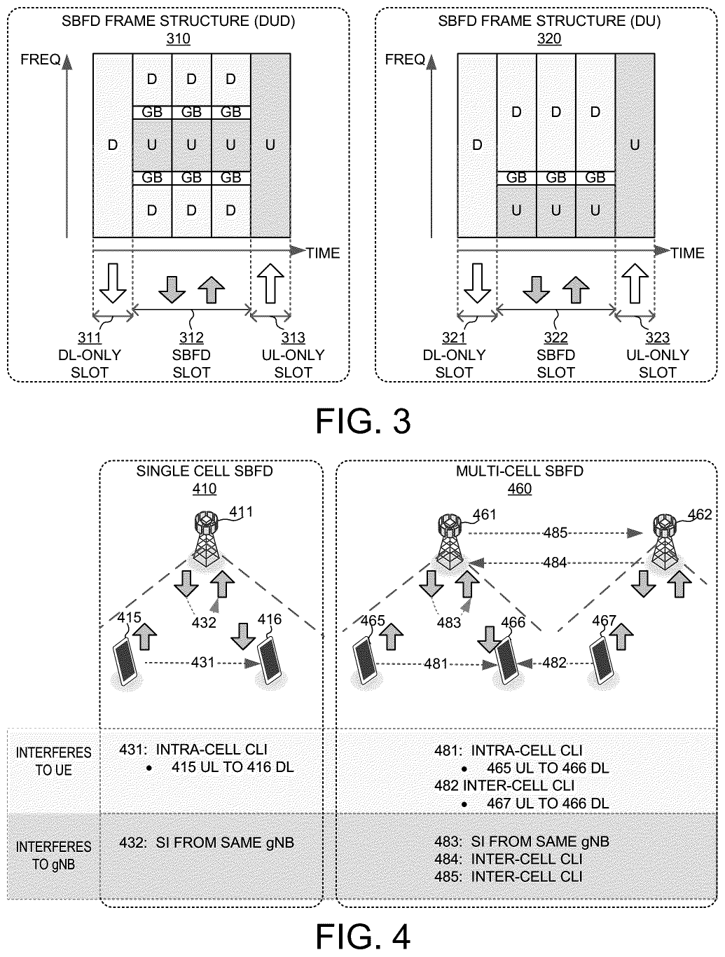

FIG. 3 illustrates exemplary diagrams different configuration of subband full duplexing frame structures in accordance with embodiments of the current invention. In one novel aspect, the wireless network is configured with SBFD to reduce latency and improve coverage. The SBFD enabled system has different frame structures. Two exemplary SBFD frame structures 310 and 320 are illustrated. SBED frame structure 310 is a DUD structure, with DL-only slot 311, SBFD slots 312 and UL-link only slot 313. SBFD frame structure 320 is a DU structure with DL-only slot 321, SBFD slots 322, and UL-only slot 323. For DL-only slot, such as 311 and 321, the frequency resources of the slot are available only in the downlink direction. For UL-only slot, such as 313 and 323, the frequency resources of the slot are available for uplink direction. For SBFD slot (X slot), such as 312 and 322, the frequency resources of the slot are shared in both downlink and uplink directions. As an example, SBFD 312 is structured in the frequency domain as DUD, downlink, uplink, downlink, with guard band in between. SBFD 322 is structured in the frequency domain as DU, downlink and uplink, with guard band in between. In one novel aspect, two sets of CSI-RS and SRS are configured when SBFD are configured together with the DL-only and/or the UL-only frames.

FIG. 4 illustrates exemplary diagrams for SBFD deployment scenarios including single cell SBFD and multi-cell SBFD scenario in accordance with embodiments of the current invention. In one novel aspect, two sets of CSI-RS configuration and two sets of CSI reports are configured for SBFD enabled system. The traditional CSI-RS, SRS and CSI reports and measurements are based on legacy interference models. For SBFD enabled system, additional cross link interference (CLI) and self-interference (SI) are introduced. Two exemplary scenarios are illustrated, including the single-cell SBFD scenario 410 and multi-cell SBFD scenario 460. For single-cell scenario 410, gNB 411 communicates with UE 415 and UE 416. As an example, intra-cell CLI 431 occurs with UL transmission from UE 415 to DL reception on UE 416. With the SBFD transceiving, gNB 411 incurs SI 432 with UL and DL in the same slot on different frequency bands. In another exemplary scenario 460, gNB 461 communicates with UE 465 and UE 466 while neighboring cell gNB 462 communicates with UE 467. As an example, UE 466 incurs intra-cell CLI 481 from UE 465, such as UL from UE 465 interferes with DL from UE 466. Further, inter-cell CLI 482 occurs between DL from UE 466 and UL of UE 467 in the neighboring cell. For gNB 461, SI 483 occurs between its UL and DL in the same slot. Inter-cell CLI 484 occurs to UL reception of gNB 461 from DL transmission of gNB 462 while inter-cell CLI 485 occurs to UL reception of gNB 462 from DL transmission of gNB 461. In one novel aspect, additional CSI-RS and SRS configurations are configured separately for the SBFD slots to count the SI, intra-cell CLI and inter-cell CLI.

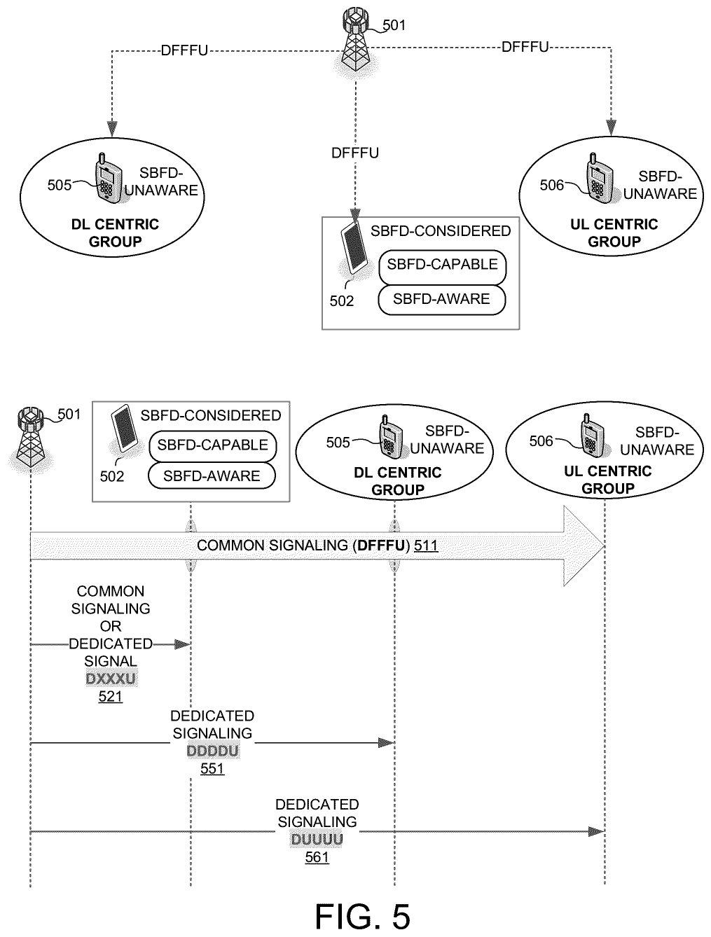

FIG. 5 illustrates exemplary diagrams for SBFD signaling to SBFD-considered UE and SBFD-unaware UEs in accordance with embodiments of the current invention. In one novel aspect, with the SBFD enabled in the wireless system, the network configures the transceiving resources to SBFD-considered and SBFD-unaware UEs with common signaling and/or dedicated signaling based on the UE capabilities. As an example, gNB 501 connects with SBFD-considered UE 502, SBFD-unaware UE 505 and SBFD-unaware UE 506. In one embodiment, SBFD-considered UE 502 is either an SBFD-capable UE or an SBFD-aware UE. In one example, when the SBFD is configured, the network informs all the UE, including the SBFD-considered UEs and the SBFD-unaware UEs, with DFFFU, where D indicates DL-only slot, U indicates UL-only slot and F representing flexible slots. As an example, UE 505, the SBFD-unaware UE, is in a DL-centric group, and UE 506, the SBFD-unaware UE, is in a UL-centric group.

In one novel aspect, SBFD is configured for the wireless network. gNB 501 intends to use SBFD with the mix of DL-only slot (s), UL-only slot (s) and SBFD slot (s) in the time domain. For example, the intended frame structure is DXXXU, where X represents SBFD slots. gNB 501, at step 511, signals all UEs, including SBFD-considered UE 502, SBFD-unaware UE 505 and SBFD-unaware UE 506, with common signaling indicating DFFFU. For the SBFD-considered UE 502, gNB sends another common signaling or dedicated signal indicating DXXXU to UE 502. For the SBFD-unaware UEs, gNB 501 can schedule UE 505 and UE 506 in the SBFD slot. At step 551, gNB 501 sends dedicated signaling to UE 505 in the DL-centric group, indicating DDDDU. At step 561, gNB 501 sends dedicated signaling to UE 506 in the UL-centric group, indicating DUUU. In one embodiment, the SBFD-considered UE 502, being either SBFD-capable UE or SBFD-aware UE, can use DL and UL resources in the SBFD slot based on the network configuration. In one embodiment, two sets of CSI-RS and CSI reports are configured for UE that uses the SBFD slots.

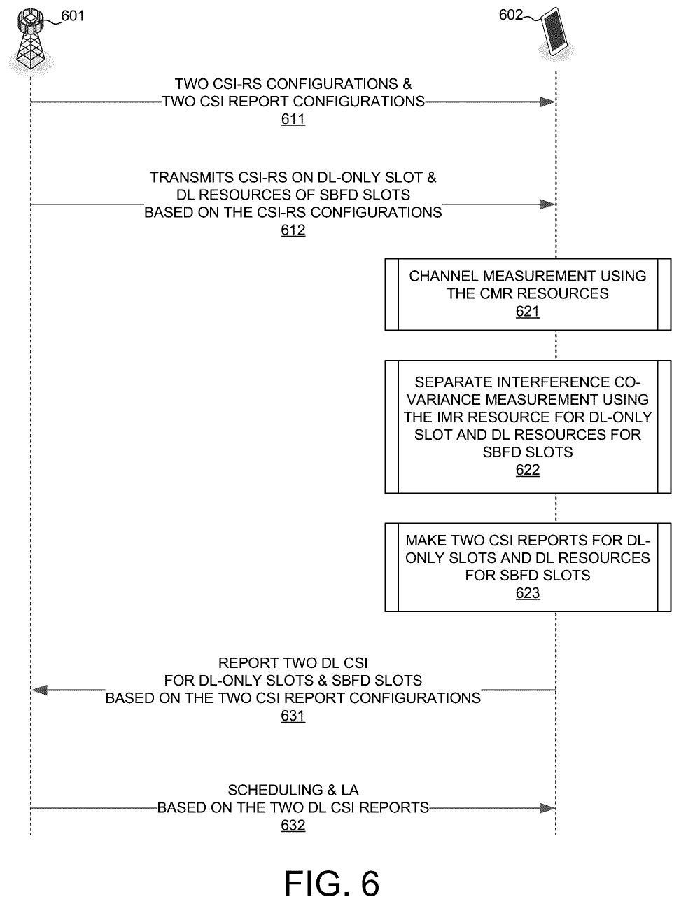

FIG. 6 illustrates exemplary flow diagrams for DL CSI configuration and CSI report for SBFD enabled system in accordance with embodiments of the current invention. In one novel aspect, two DL CSI are needed to the SBFD-considered UEs. UE 602 is connected with gNB 601. The interference pattern between DL-only slot and DL resources of SBFD slots are not the same. The DL reception at the UE on DL-only slot is affected by the inter-cell co-channel interference (CCI). The DL reception at the UE on the DL resources of SBFD slot is additionally affected by the inter-cell and intra-cell UE to UE inter-subband CLI. The CSI estimation on DL-only slot cannot be used for DL resources on SBFD slot while scheduling and link adaptation (LA).

At step 611, gNB 601 sends two CSI-RS configurations and two CSI report configurations to UE 602. The CSI-RS configuration includes two major configurations, the CSI-RS bandwidth and the CSI-RS periodicity/CSI-RS aperiodic. CSI-RS bandwidth configuration includes subband CSI-RS for SBFD slot and wideband CSI-RS for DL-only slot. In one embodiment, the periodicity of CSI-RS for SBFD slot and the DL-only slot is different because the interference profiles are different. For example, the periodicity of CIS-RS for SBFD slot is higher than the periodicity for DL-only slot. In another embodiment, aperiodic CSI-RS is configured for SBFD slots. In one embodiment, the CSI-RS configurations includes at least channel measurement resources (CMR) and interference measurement resource (IMR). gNB 601 configures individual IMRs for the DL-only slot and the DL resources of SBFD slots. In one embodiment, gNB 601 configures UE 602 with the same CMR for both the DL-only slot and the DL resources of SBFD slots. In another embodiment, gNB 601 configures individual CMRs for the DL-only slot and the DL resources of SBFD slots.

At step 612, gNB 601 transmits CSI-RS on DL-only slot and DL resources of SBFD slots based on the CSI-RS configurations. At step 621, UE 602 performs channel measurements using the CMR resources. In one embodiment, individual CMR for DL-only slot and DL resources of SBFD slot are configured, and the channel measurement is done at the UE using the CSI-RS received separately on DL-only slot and DL resources of SBFD slot. In another embodiment, same CMR for DL-only slot and DL resources of SBFD slot is configured, and the channel measurement is done at the UE using the CSI-RS received on the DL-only slot. The same channel measurement is reused in the DL resources of SBFD slot. At step 622, UE 602 performs separate interference co-variance measurement using the IMR resources for DL-only slot and the DL resources of SBFD slots. Individual interference covariance measurement is performed because the interference is expected to be different in DL-only slot and DL resources of SBFD slot. At step 623, UE 602 makes two CSI reports for DL-only slot and DL resources of SBFD slots. At step 631, UE 602 reports two DL CSI for DL-only slots and SBFD slots based on the two CSI report configurations. At step 632, gNB 601 performs scheduling and LA based on the two CSI reports from UE 602.

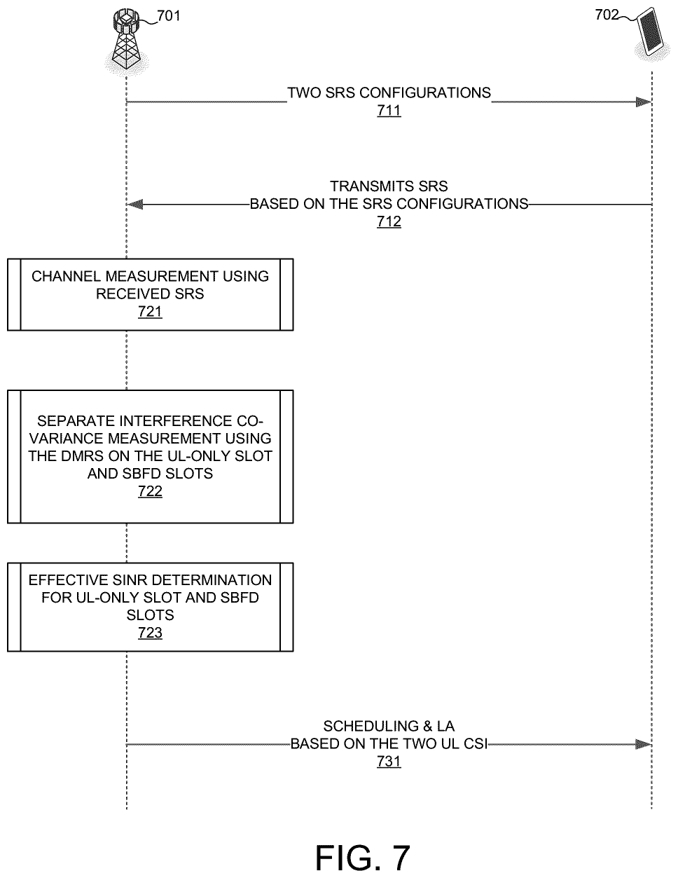

FIG. 7 illustrates exemplary flow diagrams for UL SRS configuration and SRS measurements for SBFD enabled system in accordance with embodiments of the current invention. In one novel aspect, two UL CSI are needed to the SBFD-considered UEs. UE 702 is connected with gNB 701. The interference pattern between UL-only slot and UL resources of SBFD slots are not the same. The UL reception at the gNB on UL-only slot is affected by the co-channel interference (CCI). The UL reception at the gNB on UL resources of SBFD slot is additionally affected by the self-interference (SI) and the gNB-gNB inter-subband cross-link interference (CLI). The CSI estimated on UL-only slot cannot be used for UL resources of SBFD slot while scheduling and link adaptation.

At step 711, gNB 701 sends two SRS configurations to UE 702. The SRS configuration includes two major configurations, the SRS bandwidth, and the SRS periodicity/aperiodic SRS. SRS bandwidth configuration includes subband SRS for SBFD slot and wideband SRS for UL-only slot. In one embodiment, the periodicity of SRS for SBFD slot and the UL-only slot is different. For example, the CSI estimated on UL-only slot cannot be used for UL resources of SBFD slot while scheduling and link adaptation. In another embodiment, aperiodic SRS is configured for SBFD slots. The gNB can trigger the UE for the aperiodic SRS transmission whenever gNB needs to measure the CSI of the SBFD slot. At step 712, UE 702 transmits SRS on UL-only slot and UL resources of SBFD slots based on the SRS configurations. In one embodiment, a single SRS setting for CSI measure is configured for both the UL-only slots and the SBFD slots. In another embodiment, separate SRS signals are configured for the UL-only slots and the SBFD slots.

In one embodiment, gNB 701 estimates the signal-to-interference-plus-noise ratio (SINR) using the channel and interference covariance measurements for each UL CSI. At step 721, gNB 702 performs channel measurements using the received SRS. In one embodiment, individual SRS resources are used for each CSI measurement. In another embodiment, the SRS resource on UL-only slot is used for both CSI measurement. The same channel measurement is reused in the UL resources of SBFD slot. At step 722, gNB 701 performs separate interference co-variance measurements using the demodulation reference signal (DMRS) received on the UL-only slot and UL resources of SBFD slot. The DMRS are transmitted by the scheduled UEs on the scheduled resources. The idea behind the individual interference covariance measurement is that the interference is expected to be different in UL-only slot and UL resources of SBFD slot. At step 723, gNB 701 performs effective SINR determination for the UL-only slots and the SBFD slots. The SINR estimation is done for each subband. The gNB calculates the effective SINR for the physical uplink shared channel (PUSCH) resources using the estimated SINR. Power density offset (PDO) between the PUSCH and SRS is estimated. The effective SINR is calculated by applying the PDO on the estimated SINR. The effective SINR is calculated by applying the PDO on the estimated SINR.

At step 731, gNB 701 performs UL scheduling and link adaptation based on the two UL CSI. The scheduling and LA are determined based on the SINR according to slot type. gNB 701 grants the UL scheduling information to the scheduled UE 702.

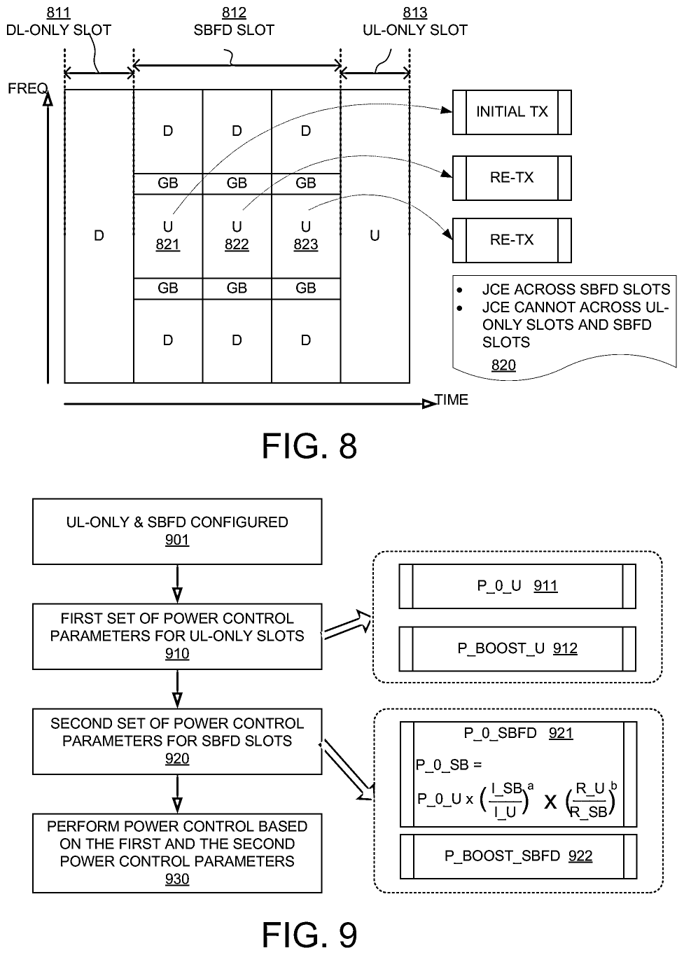

FIG. 8 illustrates exemplary diagrams for coverage extension with repetition transmission on the multiple SBFD slots in accordance with embodiments of the current invention. In one novel aspect, multiple SBFD slots are used for repeated transmission. Uplink coverage can be extended by using the transmission repetitions on multiple SBFD slots. As illustrated the SBFD enabled frame structure includes DL-only slot 811, SBFD slot 812 and UL-only slot 813. As an example, uplink resources 821, 822, and 823 of the SBFD slots are three consecutive SBFD slots allocated for the UE. The first SBFD slot, resource 821, is configured to transmit a new transport block and repeat the same transport block on the next two SBFD slots, resources 822 and 823. The gNB can receive and combine all three receptions to achieve better decoding. This scheme can increase the uplink coverage for the cell-edge UEs. In one embodiment 820, joint channel estimation (JCE) is applied across UL resources of multiple SBFD slots at the gNB. JCE can improve the channel estimation quality. Due to the difference in transmit power of UL-only slot and SBFD slot, the difference in interference level of UL-only slot and SBFD slot, and phase discontinuity on UL-only slot and SBFD slot, JCE cannot be applied across UL-only slot and SBFD slot. JCE can be applied across the multiple SBFD slots since the transmit power, the interference power and the phase continuity are expected to be similar in the SBFD slots.

FIG. 9 illustrates exemplary diagrams for uplink control with different UL power control parameters configured for the UL-only slots and the SBFD slots in accordance with embodiments of the current invention. In one novel aspect, two sets of power control parameters are configured for UL power control, one for the UL-only slots and one for the SBFD slots. At step 901, the UE is configured with UL-only slots and SBFD slots. At step 910, first set of power control parameters for UL-only slots are configure, which includes at least one of P_0_U 911, and P_boost_U 912. At step 920, the second set of power control parameters for SBFD slots are configured, including at least one of P_0_SBFD 921 and P_boost_SBFD 922. In one embodiment, the first set of the power control parameters are different from the second set of the power control parameters. In one embodiment, power boosting is required for SBFD slots to ensure better coverage and overcome the heavy SI and gNB-gNB CLI. To achieve power boosting, in one embodiment, different power control parameters, such as P_0 and alpha, are used for UL-only slot and the SBFD slots. In another embodiment, the gNB signals an explicit power boosting value P_boost. In yet another embodiment, close loop power control is used. For accumulating TPC, accumulation is performed separately for the UL-only slots and the SBFD slots. For absolute TPC, only max +4 dB can be achieved. In one embodiment, the P_0 parameter is optimized based on CLI measurements. P_0_U 911 is assume. P_0_SBFD 921 is regulated proportional to CLI-RSSI measurement as:

$$P\_ 0 \_SB = P\_ 0 \_U \times {( \frac{I\_SB}{I\_U} )}^{a} \times {( \frac{R\_U}{R\_SB} )}^{b}$$

where I_SB and I_U are the CLI-RSSI measurements in SBFD and UL-only slots measured by UE, and R_SB and R_U are the sum of SRS-RSRP measurements in SBFD and UL-only slots measured from other UEs. Two regulators a and b are fine-tuned for better NW UL Tput. At step 930 power control is performed based on the first and the second set of power control parameters. In one embodiment, UL CSI measurements and LA (rank and MCS) are further based on the corresponding power control assumptions.

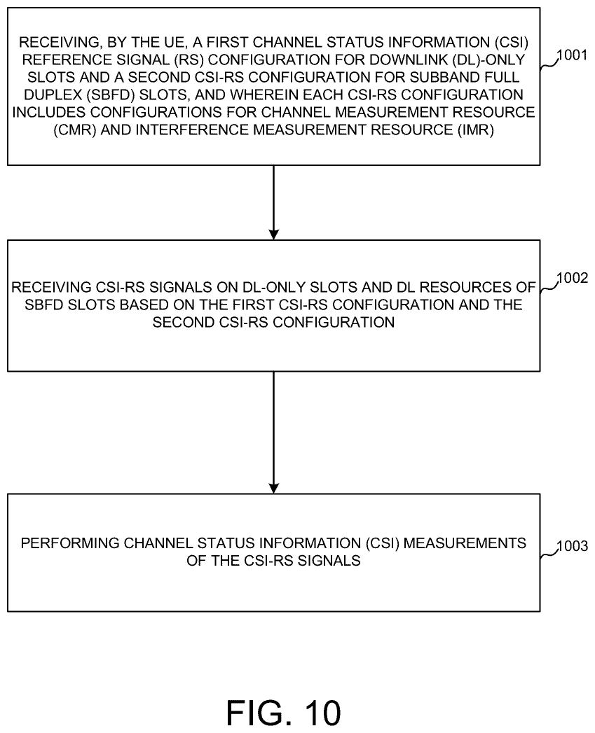

FIG. 10 illustrates an exemplary flow chart for the UE to perform CSI for SBFD enabled channel in accordance with embodiments of the current invention. At step 1001, the UE receives a first channel status information (CSI) reference signal (RS) configuration for downlink (DL)-only slots and a second CSI-RS configuration for subband full duplex (SBFD) slots, and wherein each CSI-RS configuration includes configurations for channel measurement resource (CMR) and interference measurement resource (IMR). In one embodiment, the UE is SBFD-considered UE. At step 1002, the UE receives CSI-RS signals on DL-only slots and DL resources of SBFD slots based on the first CSI-RS configuration and the second CSI-RS configuration. At step 1003, the UE performs channel status information (CSI) measurements of the CSI-RS signals.

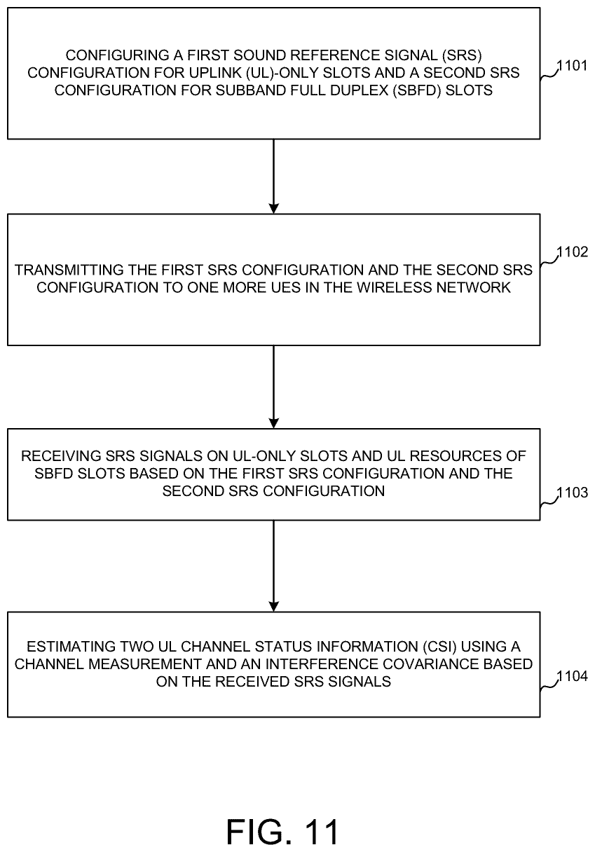

FIG. 11 illustrates an exemplary flow chart for the gNB to perform CSI for SBFD enabled channel in accordance with embodiments of the current invention. At step 1101, the gNB configures a first sounding reference signal (SRS) configuration for uplink (UL)-only slots and a second SRS configuration for subband full duplex (SBFD) slots. At step 1102, the gNB transmits the first SRS configuration and the second SRS configuration to one more UEs in the wireless network. At step 1103, the gNB receives SRS signals on UL-only slots and UL resources of SBFD slots based on the first SRS configuration and the second SRS configuration. At step 1104, the gNB estimates two UL channel status information (CSI) using a channel measurement and an interference covariance based on the received SRS signals.

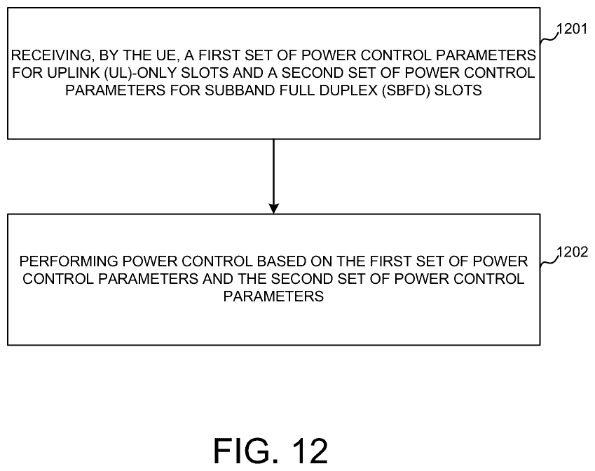

FIG. 12 illustrates an exemplary flow chart for the UE to perform UL power control for SBFD enabled channel in accordance with embodiments of the current invention. At step 1201, the UE receives a first set of power control parameters for uplink (UL)-only slots and a second set of power control parameters for subband full duplex (SBFD) slots. At step 1202, the UE performs power control based on the first set of power control parameters and the second set of power control parameters.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) in a wireless network comprising:
receiving, by the UE, a first channel status information (CSI) reference signal (RS) configuration for downlink (DL)-only slots and a second CSI-RS configuration for subband full duplex (SBFD) slots, and wherein each CSI-RS configuration includes configurations for channel measurement resource (CMR) and interference measurement resource (IMR);
receiving CSI-RS signals on DL-only slots and DL resources of SBFD slots based on the first CSI-RS configuration and the second CSI-RS configuration; and
performing channel status information (CSI) measurements of the CSI-RS signals.

2. The method of claim 1, wherein the UE estimates an interference covariance individually on IMRs configured for DL-only slots and SBFD slots.

3. The method of claim 1, wherein a common CMR is configured for DL-only lots and SBFD slots.

4. The method of claim 3, wherein the UE performs channel estimation using the CSI-RS configured on the CMR.

5. The method of claim 1, wherein CMR contents for the first RS configuration and the second RS configuration are different.

6. The method of claim 5, wherein the UE performs channel estimation individually using the CSI-RS configured for the DL-only slots and CSI-RS configured for SBFD slots.

7. The method of claim 1, further comprising: receiving a first CSI report configuration for DL-only slots and a second CSI report configuration for SBFD slots.

8. The method of claim 1, wherein the CSI-RS signals are periodic or aperiodic, and wherein for periodic CSI-RS signals the periodicity of CSI-RS for SBFD slots and DL-only slots are different.

9. The method of claim 1, further comprising:
receiving a first sounding reference signal (SRS) configuration for uplink (UL)-only slots and a second SRS configuration for subband full duplex (SBFD) slots; and
transmitting SRS signals on UL-only slots and SBFD slots based on the first SRS configuration and the second SRS configuration.

10. The method of claim 9, wherein the SRS signals are periodic or aperiodic, and wherein for periodic SRS signals the periodicity of SRS for SBFD slots and UL-only slots are different.

11. A method for a base station in a wireless network comprising:
configuring a first sounding reference signal (SRS) configuration for uplink (UL)-only slots and a second SRS configuration for subband full duplex (SBFD) slots;
transmitting the first SRS configuration and the second SRS configuration to one more UEs in the wireless network;
receiving SRS signals on UL-only slots and UL resources of SBFD slots based on the first SRS configuration and the second SRS configuration; and
estimating two UL channel status information (CSI) using a channel measurement and an interference covariance based on the received SRS signals.

12. The method of claim 11, wherein the base station performs channel estimation individually using the SRS for the UL-only slots and SRS for SBFD slots.

13. The method of claim 11, the base station performs joint channel estimation (JCE) across at least two SBFD slots.

14. The method of claim 11, wherein the base station estimates the interference covariance individually using received demodulation reference signal (DMRS) individually on UL-only slots and UL resources of SBFD slots.

15. The method of claim 11, wherein the SRS signals are periodic or aperiodic, and wherein for periodic SRS signals the periodicity of SRS for SBFD slots and UL-only slots are different.

16. The method of claim 11, further comprising:
configuring a first CSI-RS configuration for downlink (DL)-only slots and a second CSI-RS configuration for SBFD slots;
configuring a first CSI report for DL-only slots and a second CSI report for SBFD slots;
transmitting the first CSI-RS configuration and the second CSI-RS configuration to one or more UEs;
transmitting the first CSI report configuration and the second CSI report configuration to one or more UEs; and
receiving a first CSI report and a second CSI report from each of the one or more UE.

17. The method of claim 16, wherein the CSI-RS signals are periodic or aperiodic, and wherein for periodic CSI-RS signals the periodicity of CSI-RS for SBFD slots and DL-only slots are different.

18. The method of claim 16, wherein the first CSI report and the second CSI report are periodic or aperiodic, and wherein for periodic CSI reports the periodicity of CSI report for SBFD slots and DL-only slots are different.

19. A method for a user equipment (UE) in a wireless network, comprising:
receiving, by the UE, a first set of power control parameters for uplink (UL)-only slots and a second set of power control parameters for subband full duplex (SBFD) slots; and
performing power control based on the first set of power control parameters for UL-only slots and the second set of power control parameters for SBFD slots.

20. The method of claim 19, wherein at least one of a first P_0 and a first P_boost are included in the first set of power control parameters and at least one of a second P_0 and a second P_boost are included in the second set of power control parameters.

21. The method of claim 20, the first P_0 is different from the second P_0.

22. The method of claim 20, the second P_0 is derived from the first P_0 and the second P_boost .
